(19) United States
(12) Patent Application Publication
(10) Pub. No.: US 2008/0027911 A1
(43) Pub. Date: Jan. 31, 2008

(54) Language Search Tool

(75) Inventors: Mohamed Abbar, La Defense (FR); Athapan Arayasantiparb, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/460,903

(22) Filed: Jul. 28, 2006

(51) Int. Cl. G06F 17/30

(52) U.S. Cl. 707/3

(57) ABSTRACT

A method of identifying one or more strings from a database of strings based on an input string is described. A user provides an input string, which is received and processed to produce one or more search terms. These search terms are compared to the database to identify potential matches and the potential matches are then filtered according to a field of use and the resultant strings are output to the user.

### BACKGROUND

For non-native speakers of a language, the correct use of proverbs and idioms is problematic. A non-native speaker may find it difficult to ensure that the order of words is correct particularly where the meaning of a phrase cannot be determined from analysis of the constituent words e.g. the phrase “have bat's in one's belfry”.

### SUMMARY

The following presents a simplified summary of the disclosure in order to provide a basic understanding to the reader. This summary is not an extensive overview of the disclosure and it does not identify key/critical elements of the invention or delineate the scope of the invention, its sole purpose is to present some concepts disclosed herein in a simplified form as a prelude to the more detailed description that is presented later.

A method of identifying one or more strings from a database of strings based on an input string is described. A user provides an input string, which is received and processed to produce one or more search terms. These search terms are compared to the database to identify potential matches and the potential matches are then filtered according to a field of use and the resultant strings are output to the user.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is an example flow diagram of a method of searching for phrases;

FIG. 2 is a schematic diagram of an apparatus for performing the method of FIG. 1;

FIG. 3 shows an example flow diagram of a step from FIG. 1 in more detail;

FIGS. 4 and 5 each show an example flow diagram of a step from FIG. 3 in more detail;

FIGS. 6 and 7 each show an example diagram of a graphical user interface; and

FIG. 8 shows an example flow diagram of a step from FIG. 1 in more detail.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although dictionaries of proverbs and idioms exist in paper and electronic form, it is hard for a non-native speaker to determine the context in which a particular idiom should be used. Furthermore, if a non-native speaker inputs one or two keywords into an online dictionary, they are presented with a list of several potential idioms/proverbs and no assistance is provided to identify which of the displayed phrases is the one that the non-native speaker is most likely to want to use.

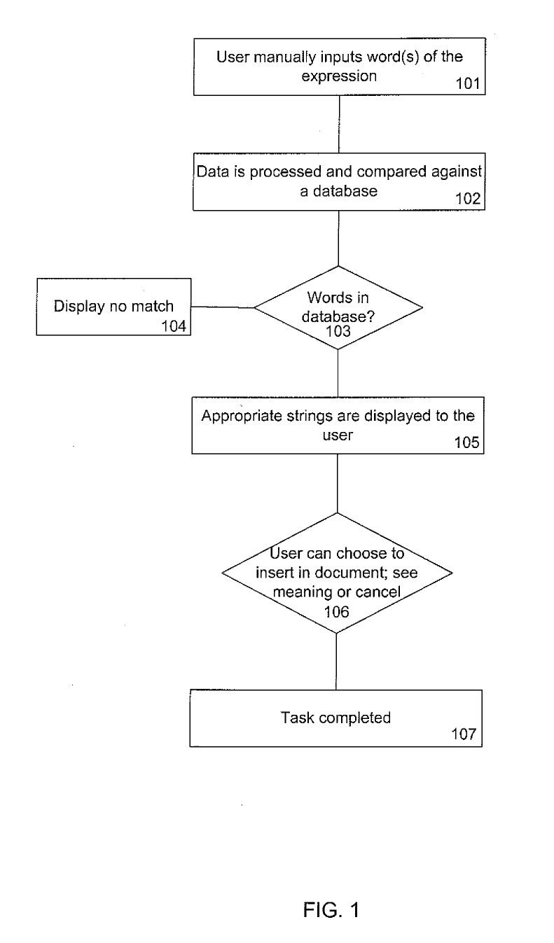

FIG. 1 is an example flow diagram of a method of searching for phrases (or other strings) which uses context information to select appropriate phrases (or other strings) for a user. The user manually inputs one or more words contained within an expression (step 101). These words may be typed into a dedicated search input box (e.g. on a web page) or may be typed within an application such as a Microsoft Office (trade mark) application, an instant messenger application, an email tool etc. The word(s) input (referred to also as an ‘input string’) are processed and compared against a database (step 102), as described in more detail below, and any matching strings are identified. If there are no matching strings (as determined in step 103), then the user is presented with a message indicating that no match has been found (step 104). In another example, where no match is found, the user may be presented with the closest identified strings e.g. those strings which have been identified based on some, but not all, of the words input by the user. If there are matching strings (as determined in step 103), the identified strings (also referred to as ‘output data’) are displayed to the user (step 105) and the user can choose to use the string, see further information relating to the string, etc (step 106) and then the task is completed (step 107). The user may subsequently decide to search for another phrase and the process may be repeated.

The term ‘string’ is used herein to refer to a linear sequence of alpha-numeric characters, which may includes spaces and/or punctuation, such as one or more words, numbers, acronyms, abbreviations or phrases.

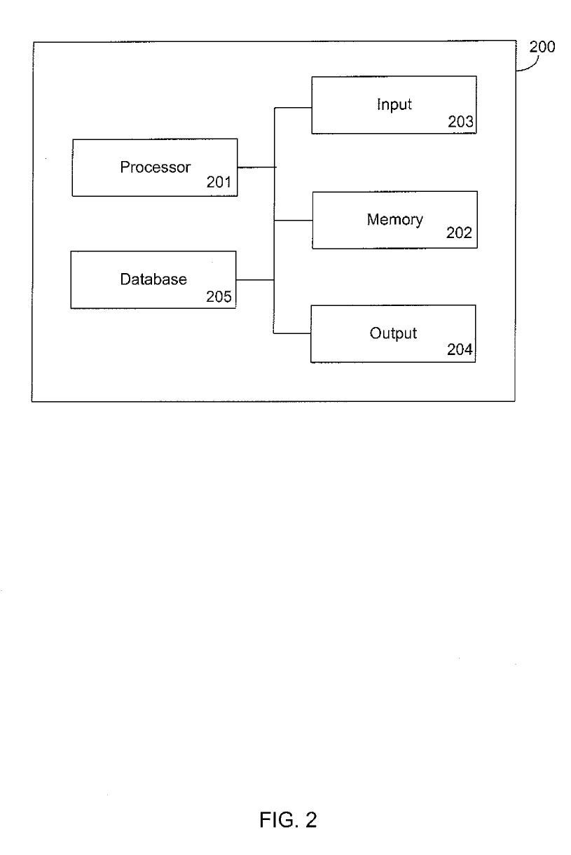

The method as shown in FIG. 1 may be implemented by an apparatus 200 as shown in FIG. 2. The apparatus comprises a processor 201 and a memory 202 arranged to store executable instructions to cause the processor 201 to perform the required steps to implement one of the methods described herein. The apparatus also comprises an input 203 for receiving an input from the user (e.g. in step 101), an output 204 for outputting the results of the search to the user (e.g. in steps 104 and 105) and a database of strings 205. The database of strings may comprise a Microsoft Excel (trade mark) file, a Microsoft Access (trade mark) database, an XML database or any other suitable collection of data. The strings in the database may comprise one or more of: idioms, common expressions, proverbs, clichés, technical terms and expressions, jargon, abbreviations, acronyms, common shorthand etc.

Although in FIG. 2 the database 205 is shown as internal to the apparatus 200, it will be appreciated that the database could be located remotely and accessed across a network (e.g. a local area network or the internet). Furthermore, it will be appreciated that the database may be operated by a third party who provides a database service. The input 203 may comprise an interface to a user input device such as a keyboard, touch sensitive screen etc or may alternatively comprise an interface to a network over which the input from the user is received (e.g. received over the internet from a user using a remote PC). The output 204 may comprise an interface to a display device such as a monitor or may alternatively comprise an interface to a network over which the output is transmitted to the user. The input 203 and output 204 may be combined, for example as an interface to a touch sensitive display or a network interface.

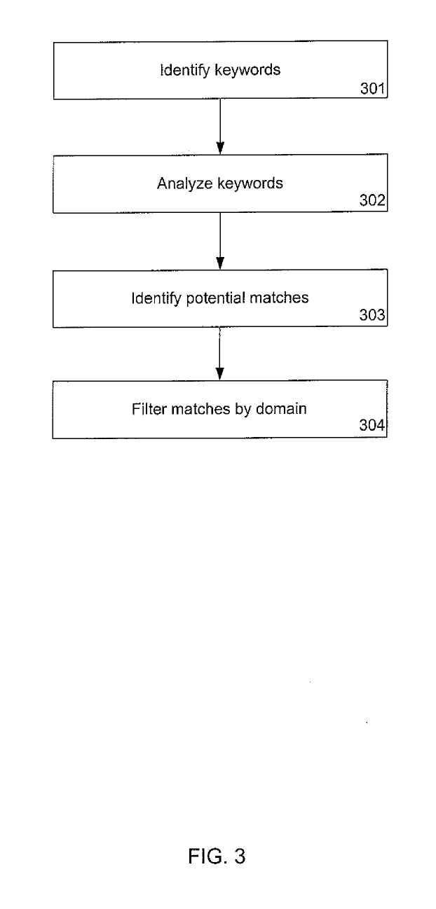

FIG. 3 shows an example of the processing and comparison step (step 102) in more detail. Keywords are identified (step 301) from the input received from the user (in step 101). This may be performed by filtering out particular parts of speech, such as one or more of prepositions (e.g. of, at, to, in, over etc), conjunctions (e.g. and, but, while etc) and pronouns (e.g. he, she, who etc). In some examples numbers and/or punctuation may also be filtered out. If for example, the user inputs “shooting from hip”, the word “from” may be filtered out leaving the two keywords: “shooting” and “hip”.

Having identified the keywords, these keywords are analyzed (step 302) to identify the root of the word, different forms of the word (e.g. alternative conjugations of verbs) etc. In the example given above, the root of “shooting” may be identified as “shoot” and alternative conjugations may include “shot”, “shoots” etc. The root of “hip” may be identified as “hip” and alternative forms may include “hips” (the plural form). An example method of identifying the different forms of a word is described at http://www.phon.ucl.ac.uk/home/dick/enc/morphology.htm which is incorporated herein by reference. Where the method is implemented within an application which contains a spelling and/or grammar function, the spelling and/or grammar engine may be used in this analysis. The analysis of the keywords may also include identification of alternative spellings (e.g. “colour” and “color”) or common misspellings of words. The result of this analysis may therefore be a number of words related to each of the identified keywords, for example:
Keyword=shooting
Related words: shooting, shoot, shot, shoots
Keyword=hip
Related words=hip, hips

### These related words are also referred to as ‘search terms’.

The words identified in the analysis (in step 302) are then used in identifying potential matching strings within the database (step 303). This identification process may be performed using look-up tables or any means for searching the database of strings to identify those strings containing one or more of the words identified In the analysis. Potential matches may be identified as those strings containing at least one of the identified words (or search terms) relating to each of the keywords identified e.g. strings containing one of “shooting”, “shoot”, “shot” and “shoots” and also one of “hip” and “hips” in the example given above. In some situations, this step will only identify one potential match; however, where fewer keywords are identified (in step 301) more matches may be identified. In another example, where n keywords are identified (in step 302), potential matches may first be sought which contain at least one of the identified words relating to each of the n keywords (as described above), however, if no potential matches are identified, the search may be repeated to look for potential matches which contain at least one of the identified words relating to m₁ keywords from the set of n identified keywords (where m₁<n, e.g. m₁=n−1). If this still does not identify any potential matches the process may be repeated again to look for potential matches which contain at least one of the identified words relating to m₂ keywords from the set of n identified keywords (where m₂<m₁<n, e.g. m₂=m₁−1=n−2), and so on until a potential match is identified or the routine stops (e.g. after a predefined number of iterations or where mₓ=0).

The potential matching strings are then filtered by domain (step 304). The word ‘domain’ (also referred to herein as a ‘classification’) is used herein to refer to a particular sphere (or field) of use of a string, such as “business”, “slang”, “popular use” etc. The domains (or classifications) may in some examples be more specific, for example by being limited to a particular type of business such as “marketing”, “legal”, “sales”, “communications”, “banking”, “media” etc. Each string in the database is categorized by one or more domains and the applicable domains for each string within the database are recorded in the database of strings, for example:

| | Domain: | Domain: | Domain: |
|---|---|---|---|
| String | business | popular use | slang |
| Shoot the messenger | X | X | |
| Shoot from the hip | | X | |

or:

| String | Domains/Classifications |
|---|---|
| Shoot the messenger | Business, Popular use |
| Shoot from the hip | Popular use |

It will be appreciated that these represent only two possible ways in which domains may be associated with strings within the database. As shown above, a string may be associated with one or more domains.

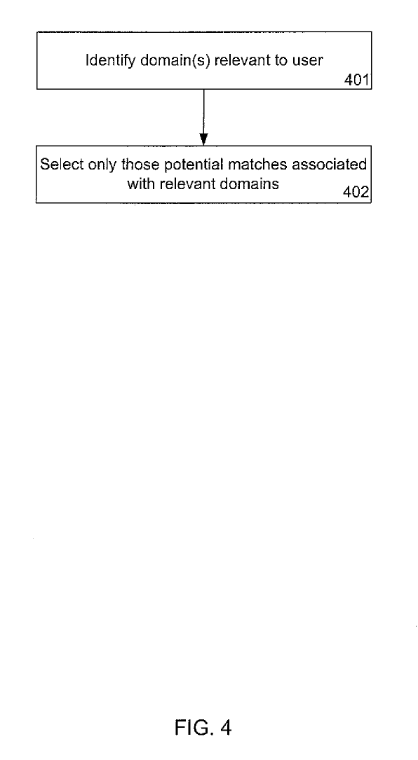

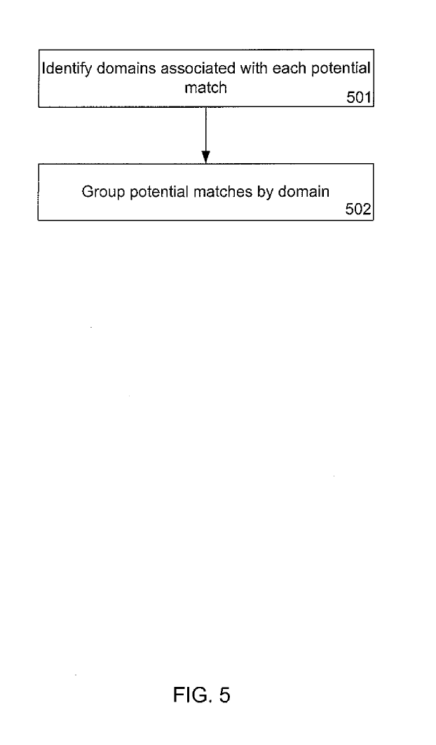

FIGS. 4 and 5 show two example methods for filtering the potential matching strings by domain (step 304). The methods may be implemented using one of these methods (or an alternative method) or in another example, the user may be able to select which method should be used, (e.g. display only those strings in relevant domain, as in FIG. 4, or display all strings with their domain information, as in FIG. 5). This may be configured by the user in a profile or alternatively may be a search option which may be selected when performing each search (e.g. “Search for all phrases” or “Search for relevant phrases only”).

In a first example, as shown in FIG. 4, the domain(s) relevant to the user are identified (step 401). This identification may be done in one of a number of ways, including, but not limited to:
analysis of the current activity of the user (e.g. they are writing a business letter, therefore the relevant domain=business, or they are communicating via instant messenger, therefore the relevant domain=popular use);
a asking the user (e.g. via a pop-up window with selection buttons);
determination based on calendar information for the user and/or time and day information; and
a determination based on user profile information/settings (e.g. the user may be at work and this may be identified in his profile).
   Having identified the relevant domains (in step 401), the potential matches (identified in step 303) are filtered to remove any strings that do not relate to one of the relevant domains, to leave a set of matching strings which each relate to at least one of the identified relevant domains (step 402). This set of matching strings (or output data) may be subsequently displayed to the user (in step 105). The domain information therefore enables inappropriate strings to be filtered out and not displayed to the user.

In a second example, as shown in FIG. 5, the domains associated with each of the potential matches are identified (step 501) using the information stored in the database of strings and the potential matches are then grouped by domain (step 502). These matches (which once grouped comprise output data) may then be displayed to the user (in step 105) arranged by domain, for example:

Domain=Business
“Shoot the messenger”

Domain=Popular Use
“Shoot the messenger”
“Shoot from the hip”

### The domain information therefore provides additional context information for the user to enable them to make an informed decision as to which phrase to use.

Although FIG. 3 shows the step of filtering potential matches by domain (step 304), it will be appreciated that this step may be omitted where only one potential match is identified (in step 303). However, it may still be beneficial in some examples to filter the matches (e.g. using the method of FIG. 4 or FIG. 5) with a single potential match because this match may not be appropriate for the context that the user is intending and therefore the domain information may either filter out the potential match as not relevant (in step 402) and then inform the user that there were no suitable matches identified or alternatively may provide the user with the context information (using method of FIG. 5) such that the user can make that informed decision that the match is not suitable.

Although the step of filtering the potential matches is described above as being part of the data processing and comparison step (step 102), the filtering step may alternatively be performed at other points within the method of FIG. 1, for example as part of the display step (step 105).

Once the matching strings have been displayed to the user (in step 105), the user can then choose whether to use any of the strings. The user may also, in some examples, be given an option to view additional further information relating to one or more of the strings (as described below). The user may be presented with a window enabling him to insert a phrase into the document (or other file) that he is working on or alternatively the user may be able to cut/copy a string from the display window and paste it into a file as required.

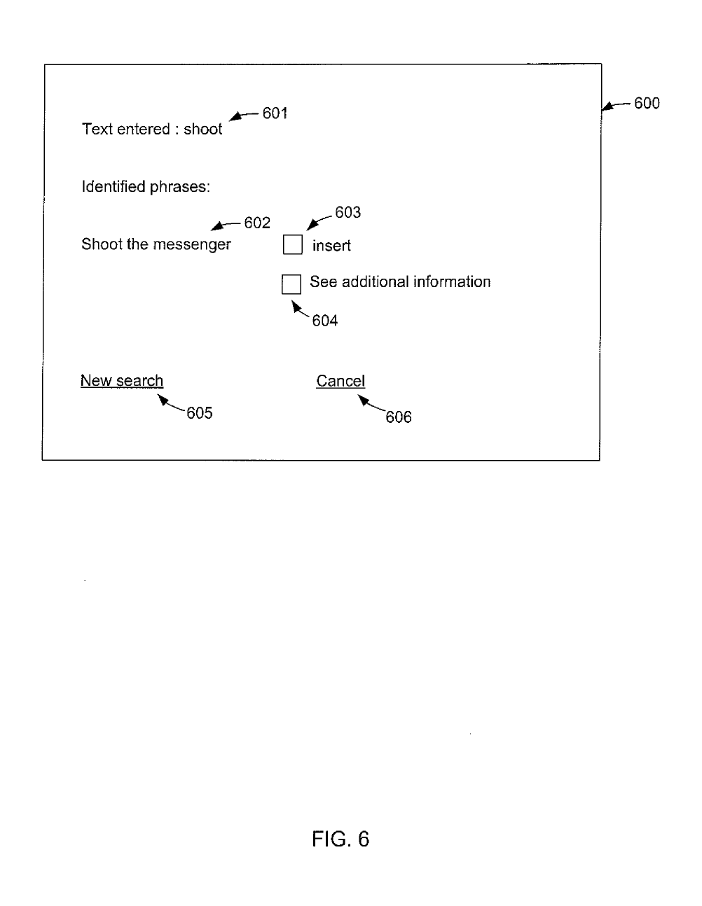

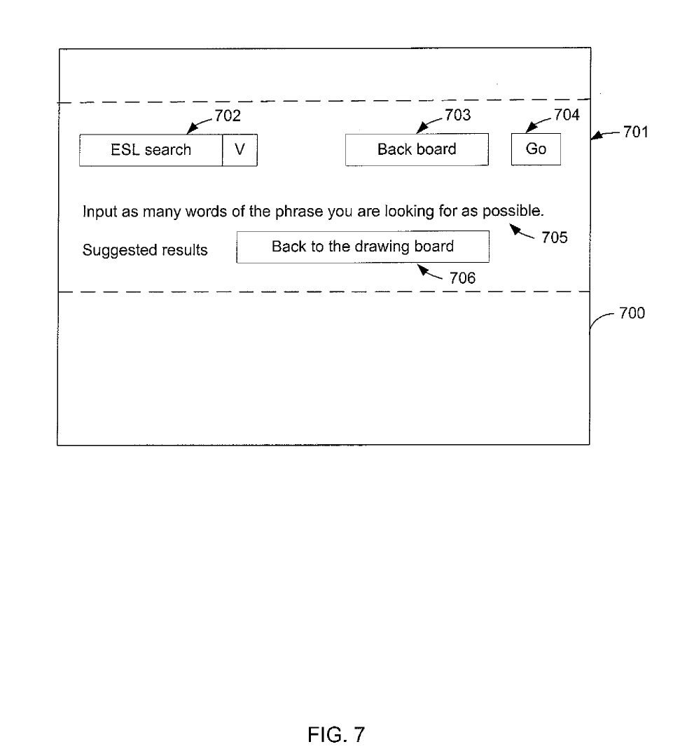

The database of strings 205 may also include further information relating to each of the strings or such further information may be stored in a separate data store (not shown in FIG. 2). The further information may include information on the meaning of each string, an example of the use of each string (e.g. an example sentence or paragraph including the string), further guidance on the use of the string (e.g. “Whilst this string is suitable for use amongst friends, it is inappropriate for use with business acquaintances”), audio files giving the correct pronunciation of the string, derivations of the string, images relating to the string etc. These options may be presented to the user within the same window which enables them to use the text, as shown in FIG. 6 which shows an example window from a graphical user interface (GUI). The window 600 includes the text entered by the user 601, any identified phrases 602 and controls enabling the user to insert the text (button 603), request additional information (button 604), perform a new search (link 605) or cancel the operation (link 606). FIG. 7 shows a second example of a GUI where the information is presented as a frame 701 which may be incorporated within a larger window 700 (e.g. within a home page or other web page or application help page). The frame 701 includes a pull down menu 702 to select the type of search required (e.g. ESL search, where ESL=English as Second Language), a box 703 for input and display of words input by the user and a button 704 to initiate the search. The frame may also include brief instructions 705 and the results may be displayed in a further box 706. It will be appreciated that the examples of a GUI shown in FIGS. 6 and 7 are by way of example only. A GUI may comprise some or all of the elements described above and may also comprise additional elements not shown in FIGS. 6 and 7.

In the above description, prepositions and other parts of speech are filtered out in order to identify the keywords (step 301). However, in some examples, some or all of these filtered out parts of speech may be used to filter the potential matches (either before or after the filtering by domain, step 304), for example where a very large number of potential matches are identified (in step 303).

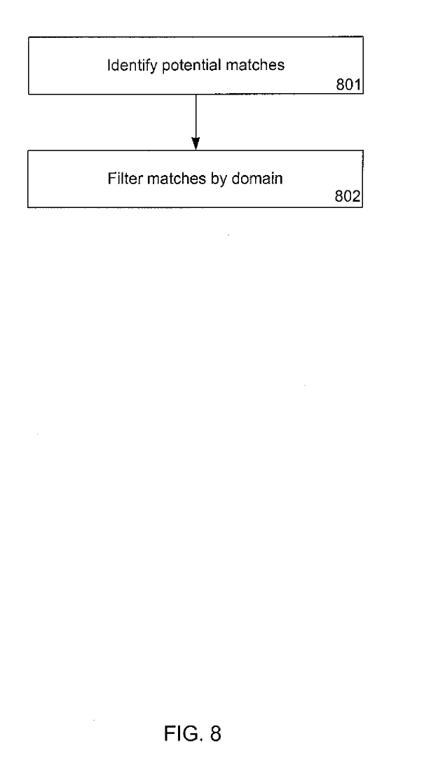

In the above description, the user inputs words contained within a string that he is trying to identify. In another example, the user may input an acronym or abbreviation (e.g. a common abbreviation, an abbreviation used in text messaging etc). In such an example, the processing and comparison step (step 102) may comprise, as shown in FIG. 8, identifying potential matches within the domain (step 801) by performing a table look-up or database search (as described above). The potential matches are then filtered by domain (step 802), as described above and shown in FIGS. 4 and 5. In an example, the user may input a commonly used abbreviation ‘atm’ and three potential matches may be identified:
Automatic teller machine (a machine for withdrawing money)
Asynchronous Transfer Mode (a communications technology)
Atmospheres (a unit of pressure, commonly used to indicate pressure under water)
   These potential matches may be categorized within different domains, e.g. the first match may be within the domains “commonly used phrases” and “banking”, whilst the second match may be within the domain “communications” and the third match may be within the domain “diving”. Using the filtering method as shown in FIG. 4, the domain of “communications” may be identified as relevant for the user (e.g. because they work for a communications company) and therefore the phrase “Asynchronous Transfer Mode” may be selected from the potential matches. Alternatively, using the filtering method of FIG. 5, all three potential matches may be presented to the user with the domain information:

Domain=Banking
Automatic teller machine

Domain=Commonly used phrases
Automatic teller machine

Domain=Communications
Asynchronous Transfer Mode

Domain=Diving
Atmospheres
   In addition to identifying what the acronym or abbreviation stands for (in step 102), other phrases which are related may also be identified as potential matches, such as, in the example given above, “cash point”, “hole in the wall” etc and these may also be filtered by domain, as described above, and may provide additional options for the user.

The method described above may be integrated within a software application such as a Microsoft Office (trade mark) application, an instant messenger application, an email application etc. In such an example, the input of text (in step 101) may be performed by typing into the application (e.g. within a document or an email). The method may be triggered via a control within the application (e.g. a button, an item on a menu bar, a hotkey etc) and may either search the whole document (e.g. on a sentence by sentence basis or identifying acronyms and/or abbreviations) or only the highlighted (or otherwise selected or identified) text (e,g, a phrase, expression, sentence, acronym, abbreviation etc). This functionality may be incorporated within an existing spelling/grammar function and may be checked at the same time as the spelling/grammar or independently.

In the above description, the running of the method is initiated by the user (e.g. by clicking on a button or other control). However, the method may alternatively run automatically when triggered by a software application. For example the method may be triggered by pressing the ‘send’ button within an email application such that the email is searched for keywords (in the same way as searching a whole document, as described above). In another example, the method may be triggered by pressing the ‘send’ (or equivalent) button within an instant messenger application. In such examples, the user may have used acronyms, common abbreviations etc when writing their message and these may be automatically translated prior to the sending of a message such that the recipient receives the full text alternative to any acronyms or abbreviations used by the sender. In such an example, the database of strings may comprise a database of acronyms and/or abbreviations.

Although the above description relates to use of the methods described within a single language, the methods may also be used to identify corresponding idioms/expressions in different languages. For example, this information may be offered to a user as part of the further information relating to each of the strings. In this example, the database of strings 205 may further comprise corresponding strings in different languages or alternatively may comprise references to another data store where the corresponding strings in different languages may be stored. A user may be presented with an option to select the languages of interest.

Although the above introduction relates to the use of the methods described herein by a non-native speaker (e.g. a non-native English speaker for strings in English, or a non-native Spanish speaker for strings in Spanish etc), this is described by way of example only and does not provide any limitation to the applicability of the methods. The methods are also applicable for users who are native speakers for the main language of the database.

Although the present examples are described and illustrated herein as being implemented in a system as shown in FIG. 2, the system described is provided as an example and not a limitation. As those skilled in the art will appreciate, the present examples are suitable for application in a variety of different types of systems with processing capability.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices

Those skilled in the art will realize that storage devices utilized to store program instructions and data can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

The methods described herein may be performed by software in machine readable form on a storage medium. The software may be suitable for execution on a parallel processor or a serial processor such that the method steps may be carried out in any suitable order, or simultaneously.

This acknowledges that software can be a valuable, separately tradable commodity it is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Any range or device value given herein may be extended or altered without losing the effect sought, as will be apparent to the skilled person.

The steps of the methods described herein may be carried out in any suitable order, or simultaneously where appropriate.

It will be understood that the above description of a preferred embodiment is given byway of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A method comprising:
receiving an input string;
processing said input string to produce at least one search term;
comparing said at least one search term to a database of strings to identify any potential output strings;
identifying at least one classification associated with each of said potential output strings;
filtering said potential output strings based on said at least one identified classification associated with each of said potential output strings to produce output data; and
outputting said output data.

2. A method according to claim 1, wherein said input string comprises at least one word.

3. A method according to claim 1, wherein said input string comprises an abbreviation.

4. A method according to claim 1, wherein processing said input string to produce at least one search term comprises:
identifying at least one keyword from said input string; and
analyzing each said keyword to identify at least one search term associated with each said keyword.

5. A method according to claim 4, wherein identifying at least one keyword comprises:
splitting said input string into a plurality of words; and
filtering said plurality of words according to predefined criteria.

6. A method according to claim 4, wherein analyzing each said keyword to identify at least one search term associated with each said keyword comprises:
identifying alternative conjugations of each said keyword.

7. A method according to claim 4, wherein comparing said at least one search term to a database of strings to identify any potential output strings comprises:
comparing each identified search term associated with each said keyword to said database of strings; and
identifying any strings in the database comprising a search term associated with each said keyword as potential output strings.

8. A method according to claim 1, wherein a classification relates to a field of use of a string.

9. A method according to claim 1, wherein the input string is received from a user and wherein filtering said potential output strings based on said at least one identified classification associated with each of said potential output strings to produce output data comprises:
identifying at least one classification associated with said user; and
filtering said potential output strings based on said at least one identified classification associated with each of said potential output strings and on said at least one classification associated with said user to produce said output data.

10. A method according to claim 9, wherein said output data comprises one or more strings associated with one of said at least one classification associated with said user.

11. A method according to claim 1, wherein filtering said potential output strings based on said at least one identified classification associated with each of said potential output strings to produce output data comprises:
grouping said potential output strings based on said at least one identified classification associated with each of said potential output strings to produce said output data.

12. A method according to claim 11, wherein said output data comprises a list of one or more output strings arranged by classification.

13. A method according to claim 1, wherein said output data comprises one or more output strings and wherein the method further comprises:
outputting additional data associated with each of said one or more output strings.

14. A method according to claim 13, wherein said additional data comprises one or more of: a meaning of said output string; an example of use of said output string; advice on use of said output string; an audio file containing a pronunciation of said output string; derivation of said output string; an image associated with said output string and a corresponding string in a different language.

15. One or more device-readable media with device-executable instructions for performing steps comprising:
receiving an input string;
processing said input string to produce at least one search term;
comparing said at least one search term to a database of strings to identify any potential output strings;
identifying at least one classification associated with each of said potential output strings,
filtering said potential output strings based on said at least one identified classification associated with each of said potential output strings to produce output data; and
outputting said output data.

16. An apparatus comprising: a processor; and a memory arranged to store executable instructions arranged to cause the processor to:
receive an input string via an input;
process said input string to produce at least one search term;
compare said at least one search term to a database of strings to identify any potential output strings;
identify at least one classification associated with each of said potential output strings;
filter said potential output strings based on said at least one identified classification associated with each of said potential output strings to produce output data; and
output said output data via an output.

17. An apparatus according to claim 16, further comprising: a database of strings.

18. An apparatus according to claim 16, wherein said input and said output comprise a network interface.
